(19) United States
(12) Patent Application Publication
(10) Pub. No.: US 2010/0329664 A1
(43) Pub. Date: Dec. 30, 2010

(54) SHUTTER DEVICE FOR CAMERA

(76) Inventor: Dae-Soon LIM, Gyeonggi-do (KR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/668,125

(22) PCT Filed: Jan. 23, 2008
(86) PCT No.: PCT/US08/00915

§ 371 Date: Jan. 7, 2010

Related U.S. Application Data
(60) Provisional application No. 60/886,276, filed on Jan. 23, 2007.

(51) Int. Cl. G03B 9/08; H04N 5/238

(52) U.S. Cl. 396/469; 348/367; 348/E05.04

(57) ABSTRACT

A shutter device mounted in a compact device such as a camera or mobile phone is provided. The shutter device includes, a base which forms a light permeation hole through which a film or a charge coupled device (CCD) is exposed to a light; a first and second electromagnets which are mounted to opposite sides of the base; a driving arm in which one end is rotatably assembled with a side of the base between the first electromagnet and the second electromagnet; a first and second shutters which open or close the light permeation hole while concurrently rotating about a part of the base in association with the rotation of the driving arm; and a magnetic which is mounted to an end of the driving arm, and rotates the driving arm in a clockwise or counter clockwise direction while moving by the magnetic force between the first electromagnet and the second electromagnet along a direction of an electric current applied to the first and second electromagnets.

### BACKGROUND

1. Field of the Disclosure

An aspect of the present disclosure relates to a shutter device, and more particularly, to a shutter device for a camera used in a compact digital device.

2. Discussion of the Background Art

As a result of the development of digital technology, portable digital devices such as mobile communication terminals, portable game consoles, personal digital assistants (PDAs), personal multimedia players (PMPs), or digital camcorders providing camera functions have become widely used.

A camera unit mounted in such a portable digital device includes the same shutter device to photograph a picture as general cameras.

As the quantity of photographs taken by a camera mounted in a mobile phone has increased, it has become necessary to employ a mechanical shutter. Camera modules should be minimized in order to reduce the size of a mobile phone, and thus it is important to simplify the structure of the shutter device. The camera unit may cause the shutter to operate quickly in order to photograph a high quality picture.

A related art camera shutter device used for a portable digital device employs a large power source to generate a required driving mechanism so that a shutter operates quickly. Therefore, in addition to the shutter device, the size of a lens unit also increases. Theses problems affect the size of the portable digital device, and thus cause inconvenience to a user carrying the portable digital device.

### SUMMARY OF THE DISCLOSURE

The present disclosure provides a shutter device for a camera capable of being applied to a compact digital device such as a mobile phone having a shutter with a high driving performance and a compact size.

According to an aspect of the present disclosure, there is provided a shutter device for a camera, including a base which forms a light emission hole through which light passes so that a film or Charge Coupled Device (CCD) is exposed to a light source; first and second electromagnets which are mounted on respective sides of the base to oppose each other; a driving arm of which a part is disposed between the first and second electromagnets, and is rotatably connected to the side of the base; first and second shutters which rotate about a part of the base engaged with the driving arm, and opens the light emission hole; and a magnet which is disposed on the part of the driving arm between the first and second electromagnets, which moves between the first and second electromagnets in a direction in which current applied to the first and second electromagnets flows, and which rotates the driving arm in a clockwise or counter-clockwise direction.

The magnet may be polarized to provide N and S poles, and poles having the same polarity occur on first ends of the first and second electromagnets at the same time.

The magnet may be polarized to provide sequential N, S, N poles or sequential S, N, S poles, and different poles occur concurrently on the first end of the first and second electromagnets adjacent to both ends of the magnet.

An aspect of the present disclosure, there is provided a shutter device for a camera, including a base which forms a light emission hole through which light passes so that a film or Charge Coupled Device (CCD) is exposed to a light source; first and second electromagnets which are mounted in corresponding portions on a side of the base; a driving arm which is rotatably disposed between the first and second electromagnets; first and second shutters which rotate about a part of the base engaged with the driving arm, and opens the light emission hole; and at least one magnet which is disposed on a part of the driving arm, wherein the driving arm which is configured to rotate in a clockwise or counter-clockwise direction by magnetic attraction and repulsion occurring between the first and second magnets in a direction in which current applied to the first and second electromagnets flows.

The first electromagnet may include a first bobbin and a first coil wound around the first bobbin, wherein the first bobbin comprises first and second magnetic pole generators on parts thereof adjacent to the magnet; and the second electromagnet comprises a second bobbin and a second coil wound around the first bobbin, wherein the second bobbin comprises third and fourth magnetic pole generators on parts thereof adjacent to the magnet, and the first and third magnetic pole generators and the second and fourth magnetic pole generators oppose to each other.

The N and S poles may be formed on a first end of the magnet disposed between the first and third magnetic pole generators, and S and N poles may be formed on a second end of the magnet disposed between the second and fourth magnetic pole generators, or S and N poles may be formed on the first end of the magnet disposed between the first and third magnetic pole generators, and N and S poles may be formed on the second end of the magnet disposed between the second and fourth magnetic pole generators.

The first electromagnet may include a first bobbin and a first coil wound around the first bobbin, and the second electromagnet may include a second bobbin and a second coil wound around the first bobbin, and the first bobbin may include two magnetic pole generators on a part adjacent to the magnet, and the second bobbin may include a magnetic pole generator on a part adjacent to the magnet, or the first bobbin may include a magnetic pole generator on the part adjacent to the magnet, and the second bobbin may include two magnetic pole generators on the part adjacent to the magnet.

Opposite poles such as N and S poles may be formed on first and second ends of the magnet, and a pair of poles formed on the first end of the magnet may oppose a pair of poles formed on the second end of the magnet, wherein the opposing poles differ from each other.

The magnet may be formed in a ring shape, and N and S poles or S and N poles may be formed on the ends corresponding to the first and second electromagnets, and identical poles may simultaneously occur on the parts of the first and second electromagnets adjacent to first and second ends of the magnet.

The first electromagnet may include a first lower bobbin, a first upper bobbin mounted on an upper portion of the first lower bobbin, and a second coil unit wound around the first lower and upper bobbins; and the second electromagnet may include a second lower bobbin, a second upper bobbin mounted on an upper portion of the second lower bobbin, and a second coil unit wound around the first lower and upper bobbins.

The magnet may include a first magnet disposed between the first and second lower bobbins and a second magnet disposed between the first and second upper bobbins.

N and S poles or S and N poles may be formed on respective ends opposing the first and second lower bobbins, and N and S poles or S and N poles may be formed on respective ends opposing the first and second upper bobbins, wherein the poles formed on the respective ends of first and second magnets oppose to each other, and the opposing poles differ from each other. The opposing poles formed on the both ends of the first and second magnets may be disposed on a slant, and one of the first and second magnets may be formed in a ring shape, and another magnet may be formed in a bent stick shape.

The parts of the first and second lower bobbins opposing the first magnet may be bent in the same direction, and the parts of the first and second upper bobbins opposing the second magnet may be bent in a direction opposite the direction of the first and second lower bobbins.

According to another aspect of the present disclosure, there is provided a shutter device for a camera, including a base which forms a light emission hole through which light passes so that a film or Charge Coupled Device (CCD) is exposed to a light source; an electromagnet which are mounted in corresponding positions on a side of the base to correspond to each other; a driving arm which is rotatably disposed adjacent to the electromagnet mounted on the side of the base; first and second shutters which rotate about a part of the base engaged with the driving arm, and opens the light emission hole; and at least one magnet which is disposed on a part of the driving arm, wherein the driving arm which is configured to rotate in a clockwise or counter-clockwise direction by magnetic attraction and repulsion occurring between the first and second magnets in a direction in which current applied to the first and second electromagnets flows, and operates the first and second shutters.

The electromagnet may include a bobbin and a coil unit wound around the bobbin, wherein a part of the bobbin adjacent to the magnet is divided, and generates a pair of magnetic pole generators adjacent to the part of the magnet. N and S poles may be formed on part of, or on first and second ends of, the magnet.

According to an exemplary embodiment of the present disclosure, magnetic attraction and repulsion are concurrently formed the both ends of a single magnet by a magnetic filed occurring on both ends of the magnet, allowing first and second shutters connected to a driving arm quickly operating. Therefore, a photograph is taken with high definition and high quality using a camera module mounted in a compact digital device.

A pair of electromagnets are minimized, and a single magnet is used, thereby reducing the size of a shutter device.

### BRIEF DESCRIPTION OF THE DRAWINGS

FIG. 1 is a perspective view illustrating assemblies of a shutter device for a camera according to a first exemplary embodiment of the present disclosure;

FIG. 2 is an exploded perspective view illustrating a shutter device for a camera according to a first exemplary embodiment of the present disclosure;

FIGS. 3 and 4 are plan views showing cases in which first and second shutters cause a light emitting hole to open and close when a magnet polarized to provide two poles is mounted;

FIGS. 5 and 6 are plan views showing cases in which first and second shutters cause a hole to open and close when a magnet polarized to provide three poles is mounted;

FIG. 7 is an exploded perspective view illustrating a shutter device for a camera according to a second exemplary embodiment of the present disclosure;

FIG. 8 is a schematic plan view showing a case in which a magnet between first and second electromagnets of FIG. 7 is disposed on a camera body;

FIGS. 9 and 10 are plan views showing a case in which first and second magnetic shutters of FIG. 7 open and close a light emitting hole;

FIG. 11 is a schematic perspective view illustrating a main unit of a shutter device for a camera according to a third exemplary embodiment of the present disclosure;

FIGS. 12 and 13 are plan views showing a case in which first and second shutters of FIG. 11 open and close a light emission hole;

FIG. 14 is a schematic perspective view illustrating a main unit of a shutter device for a camera according to a fourth exemplary embodiment of the present disclosure;

FIG. 15 is a plan view showing a case in which first and second shutters of FIG. 14 close a light emission hole;

FIG. 16 is a side view illustrating FIG. 15 viewed from a direction A;

FIG. 17 is a plan view showing a case in which first and second shutters of FIG. 14 open a light emission hole; and

FIG. 18 is a side view illustrating FIG. 17 viewed from a direction B.

### DETAILED DESCRIPTION OF THE PREFERRED EMBODIMENT

The structure of a shutter device for a camera according to a first exemplary embodiment of the present disclosure will be explained in detail with reference to the accompanying drawings.

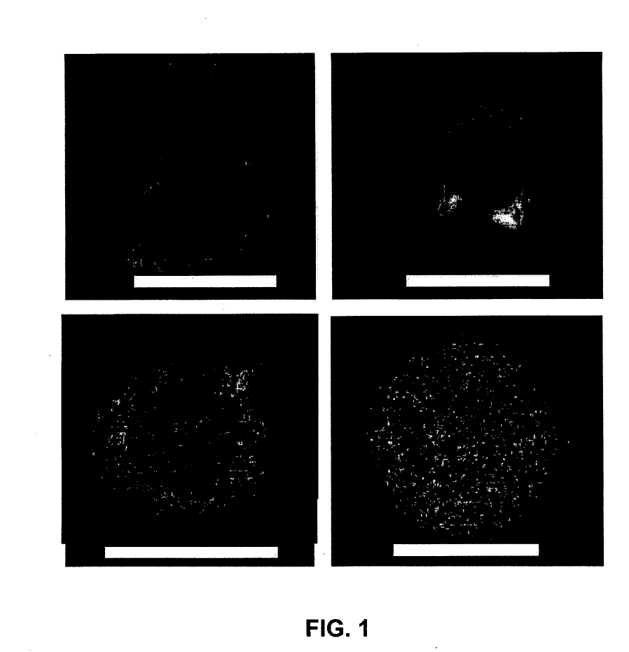

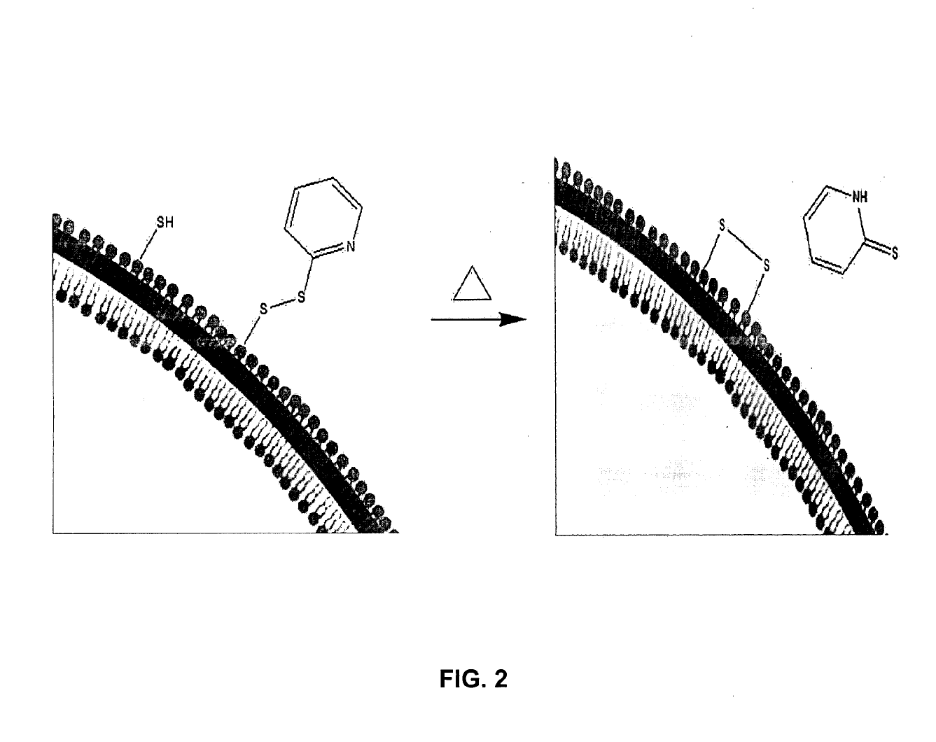

Referring to FIGS. 1 and 2, a shutter device according to the first exemplary embodiment of the present disclosure may include a base 10, first and second electromagnets 20a, 20b, a driving arm 30, a magnet 35, a flexible printed circuit board (FPCB) 40, and first and second shutters 50, 60.

The base 10 may include a body 11 formed in a circular shape and an extension unit 18 extending from the body 11.

The body 11 may include at the center thereof a first light emission hole 11a through which light may pass. A mounting groove 13 to mount first and second bobbins 21, 23 is formed around the first light emission hole 11a. The body 11 may include a plurality of fixing protrusions 15 along an outer periphery thereof so that the FPCB 40 may be fixed on the body 11. A fixing shaft 16 is formed on a boundary between the body 11 and the extension unit 18.

The extension unit 18 rotatably supports the driving arm 30, and part of the first and second electromagnets 20a, 20b is disposed on the extension unit 18 together with the driving arm 30.

The first electromagnet 20a may include the first bobbin 21 and a first coil unit 22. The first bobbin 21 includes a portion which is connected to part of the mounting groove 13, and another portion which protrudes toward the extension unit 18. The first coil unit 22 is wound around the other portion of the first bobbin 21.

The second electromagnet 20b is disposed on the base 10 opposite the first electromagnet 21a about the first light emission hole 11a. The second electromagnet 20b is also disposed identically to the first electromagnet 20a. That is, the second electromagnet 20a includes the second bobbin 23 and the second coil unit 24. The second bobbin 23 includes a first portion which is connected to another part of the mounting groove 13, and a second portion which protrudes toward the extension unit 18. The second coil unit 22 is wound around the first portion protruding toward the extension unit 18.

The driving arm 30 includes a hinge protrusion 31 to rotate in a connection hole 19, and a connection protrusion 33. The connection protrusion 33 is inserted into first and second long holes 53, 63 of the first and second shutters 50, 60 to slidably move therein. If the driving arm 30 rotates in a clockwise or counter-clockwise direction, the first and second shutters 50, 60 rotate in a direction of the driving arm 30, or in a reverse direction.

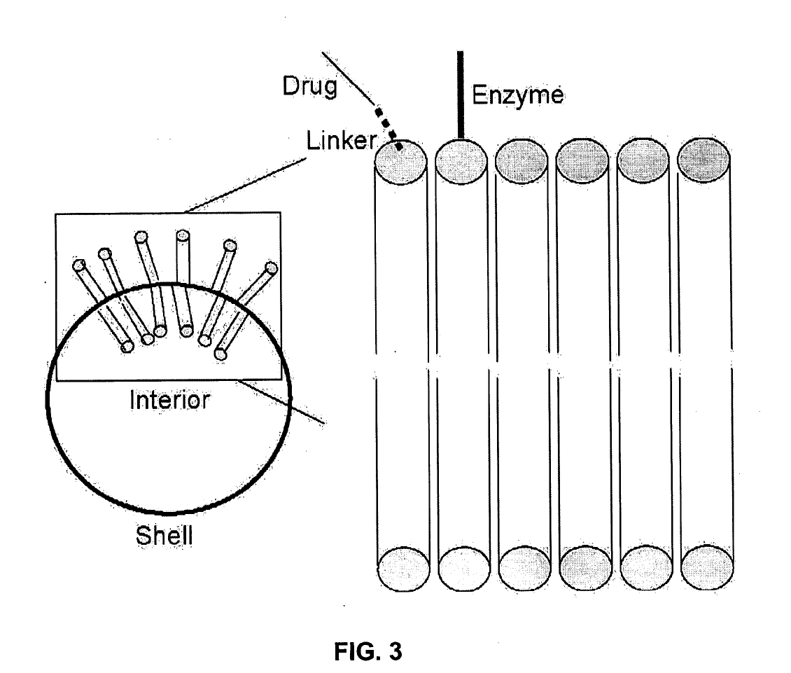

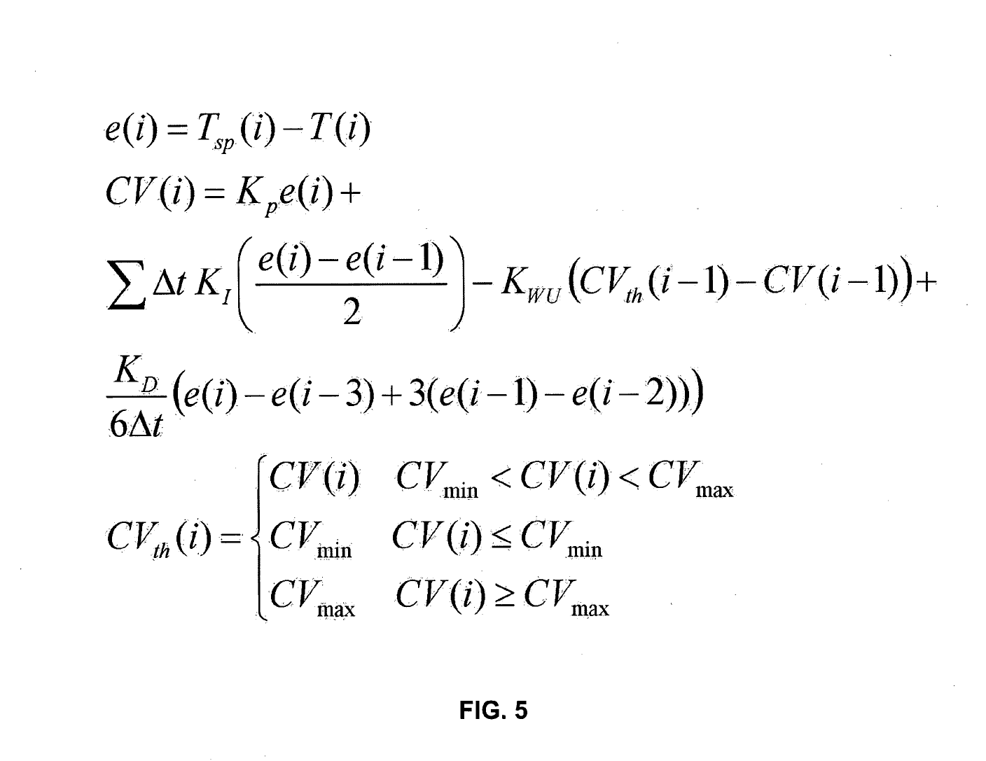

The magnet 35 is fixed to part of the driving arm 30 which is disposed between the first and second coil units 22, 24, so as to be affected by the magnetic field formed on part of the first and second coil unit 22, 24. In this case, the magnet 35 is polarized to provide two poles, that is a N pole and a S pole (referring to FIG. 3). A magnet 135 may also be polarized to provide three poles, that is N, S, and N poles, or S, N, and S poles, instead of two poles, so that the same poles are formed on both sides of the magnet 135 (referring to FIG. 5).

The FPCB 40 includes a predetermined circuit unit, and applies the current flowing on the first and second coil units 22, 24. The FPCB 40 includes a plurality of fixing grooves 45 into which a plurality of fixing protrusions 15 of the body 11 may be inserted, and thus is mounted safely in an upper portion of the body 11. The FPCB 40 includes at the center thereof a through hole 41 which corresponds to the first light emission hole 11a.

The first shutter 50 may include a first fixing hole 51, the first long hole 53, and a first main hollow unit 55. The fixing shaft 16 which is a rotating shaft of the first shutter 50 is hingeably inserted into the first fixing hole 51, and the connection protrusion 33 is slidably inserted into the first long hole 53 so that the first shutter 50 may rotate in the same direction as the driving arm 30 rotates. The first long hole 53 is formed on part of the first shutter 50 adjacent to the first fixing hole 51.

The first shutter 50 includes the first main hollow unit 55 which is the same size as or larger than the first light emission hole 11a at part of the first shutter 50, which is because the first light emission hole 11a opens completely when the first main hollow unit 55 corresponds to the circumference of the first light emission hole 11a. In this case, the first shutter 50 sets the length of the first long hole 53 appropriately, and thus limits the angle of rotation of the first main hollow unit 55 to correspond to the first light emission hole 11a.

The second shutter 60 is disposed on the opposite end of the first light emission hole 11a to the first shutter 50, and includes a second fixing hole 61, the second long hole 63, and a second main hollow unit 65 corresponding to the components of the first shutter 50. The fixing shaft 16 inserted into the first fixing hole 51 is hingeably inserted into the second fixing hole 52, and the connection protrusion 33 of the driving arm 30 inserted into the first long hole 53 is slidably inserted into the second long hole 63. The second long hole 63 is formed on part of the second shutter 60 adjacent to the second fixing hole 61.

The second shutter 60 is identical in form to the first shutter 50. That is, the second shutter 60 includes the second main hollow unit 65, which is the same size as or larger than the first light emission hole 11a, at part of the second shutter 60, since the first light emission hole 11a opens completely when the second main hollow unit 65 corresponds to the circumference of the first light emission hole 11a. The second shutter 60 sets the length of the second long hole 63 appropriately, and thus limits the angle of rotation of the second main hollow unit 65 to correspond to the first light emission hole 11a.

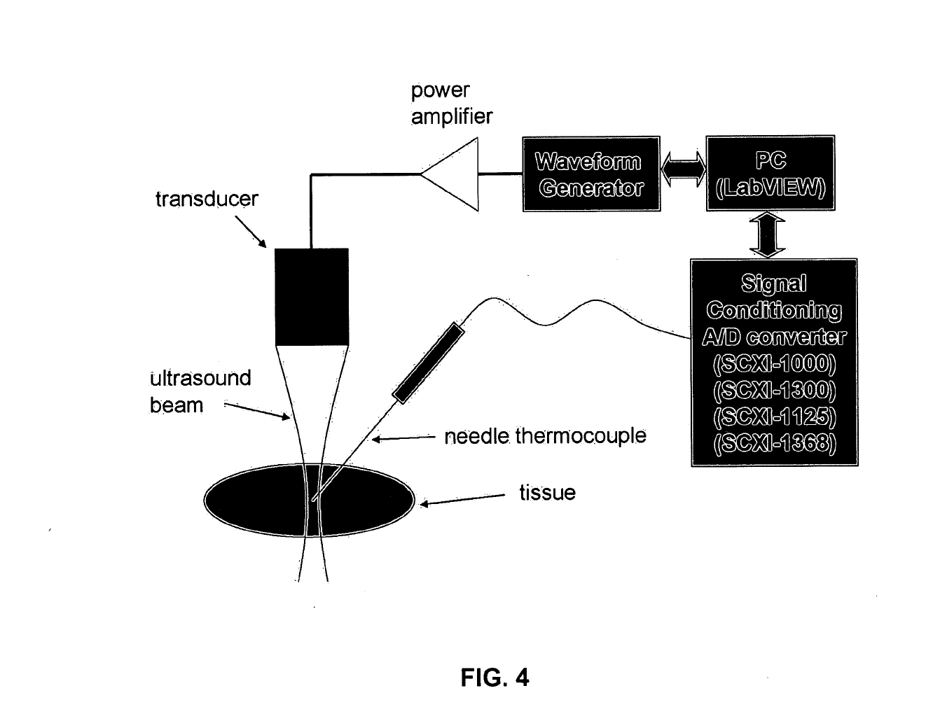

The operation of the shutter device according to the first exemplary embodiment of the present disclosure will be explained with reference to FIGS. 3 and 4. The FPCB 40 is omitted from FIGS. 3 and 4 for convenience of description.

In this exemplary embodiment of the present disclosure, the magnet 35 is polarized to provide two poles, that is N and S poles, and a magnetic field having the same poles are simultaneously formed on part of the first and second bobbins 21, 23 disposed adjacent to each end of the magnet 35.

Referring to FIG. 3, if a shutter device according to the first exemplary embodiment of the present disclosure, for example a camera (not shown), is turned on, or if a mobile phone (not shown) on which a camera is mounted is set to a photography mode, the first and second shutters 50, 60 completely close the first light emission hole 11a of the body 11, and thus a film or a charge coupled device (CCD) is set to an initial condition, in which the film or the CCD is not exposed to a light source.

If a shutter button (not shown) is pressed to take a photograph, the first and second shutters 50, 60 rotate instantaneously, thereby causing the first light emission hole 11a to open completely. The process of converting the first light emission hole 11a from being completely closedf (referring to FIG. 3) to being completely opened (referring to FIG. 4) will be explained in detail.

If current is simultaneously applied to the first and second coil unit 22, 24 of the first and second electromagnets 20a, 20b, a magnetic field having the same pole, that is the S pole, is formed on part of the first and second bobbins 21, 23 adjacent to the magnet 35.

Magnetic attraction occurring between the N pole of the magnet 35 and the S pole of the first bobbin 21 causes the magnet 35 to be attracted toward the S pole of the first bobbin 21 as shown in FIG. 4, and repulsion occurring between the S pole of the magnet 35 and the S pole of the second bobbin 23 causes the magnet 35 to be repulsed from the S pole of the second bobbin 23.

The driving arm 30 rotates in a clockwise direction about the hinge protrusion 31 (referring to FIG. 2), and the connection protrusion 33 slides along the first and second long holes 53, 63 of the first and second shutters 50, 60. The first shutter 50 rotates in a counter-clockwise direction about the fixing shaft 16, and simultaneously the second shutter 60 rotates in a clockwise direction about the fixing shaft 16. Thus, the first and second main hollow units 55, 65 are disposed on the first light emission hole 11a so that the first light emission hole 11a is opened completely.

The process of closing the first light emission hole 11a, by which the shutter device of FIG. 4 is converted into the shutter device of FIG. 3, will be explained below.

If current is simultaneously applied to the first and second coil units 22, 24 in a direction opposite the direction in which the first light emission hole 11a is opened, a magnetic field having the N pole is formed on part of the first and second bobbins 21, 23 adjacent to the magnet 35 as shown in FIG. 3.

Magnetic attraction causes the S pole of the magnet 35 to be attracted toward the N pole of the second bobbin 23, and simultaneously repulsion causes the N pole of the magnet 35 to be repulsed from N pole of the first bobbin 21.

The driving arm 30 rotates in a counter-clockwise direction about the hinge protrusion 31 (referring to FIG. 2), and the connection protrusion 33 of the driving arm 30 slides along the first and second long holes 53, 63 of the first and second shutters 50, 60. The first shutter 50 rotates in a clockwise direction about the fixing shaft 16, and the second shutter 60 rotates in a counter-clockwise direction about the fixing shaft 16. Accordingly, the first light emission hole 11a is closed completely.

The shutter device according to the first exemplary embodiment of the present disclosure causes a magnetic field generated from the first and second electromagnets 20a, 20b adjacent to each ends of the magnet 35 to concurrently generate magnetic attraction and repulsion on both sides of the magnet 35, and enhances the rotational force of the driving arm 30. Therefore, the speed of the first and second shutters 50, 60 increases, and a photograpy may be taken with high definition and high quality.

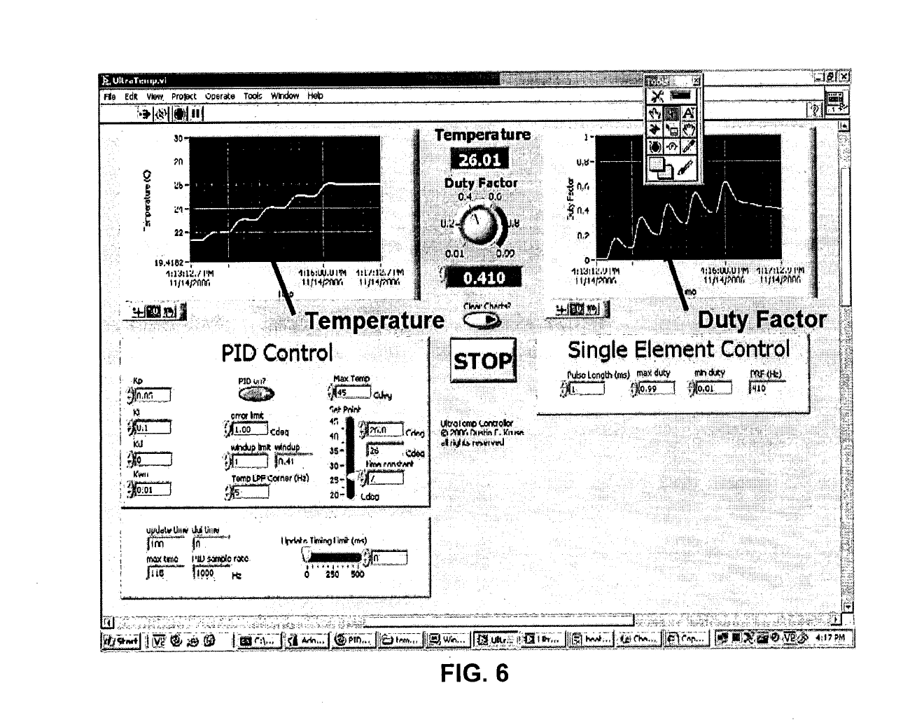

While the magnet 35 is polarized to provide two poles in this exemplary embodiment of the present disclosure, the magnet 135 polarized to provide three poles may also be used as shown in FIGS. 5 and 6. The magnet 135 may subsequently be polarized so as to have S, N, and S poles, or N, S, and N poles.

The use of the magnet 135 having N, S, and N poles is different from that of the magnet 35 having two poles as shown in FIGS. 3 and 4, in that current is concurrently applied to the first and second coil units 22, 24 to rotate the driving arm 30 in a clockwise or counter-clockwise direction, but an opposite magnetic field is formed on part of the first and second bobbins adjacent to the magnet 135.

The process of opening and closing the first light emission hole 11a by the driving arm 30 and the first and second shutters 50, 60 as shown in FIGS. 5 and 6 is identical to using the magnet 35 having two poles, so detailed description will be omitted.

The structure of a shutter device for a camera according to the second exemplary embodiment of the present disclosure will be explained in detail.

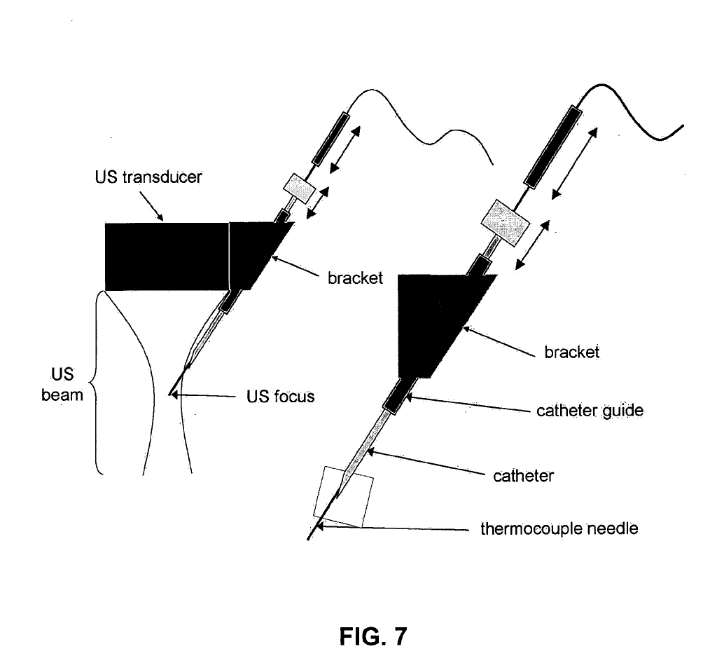

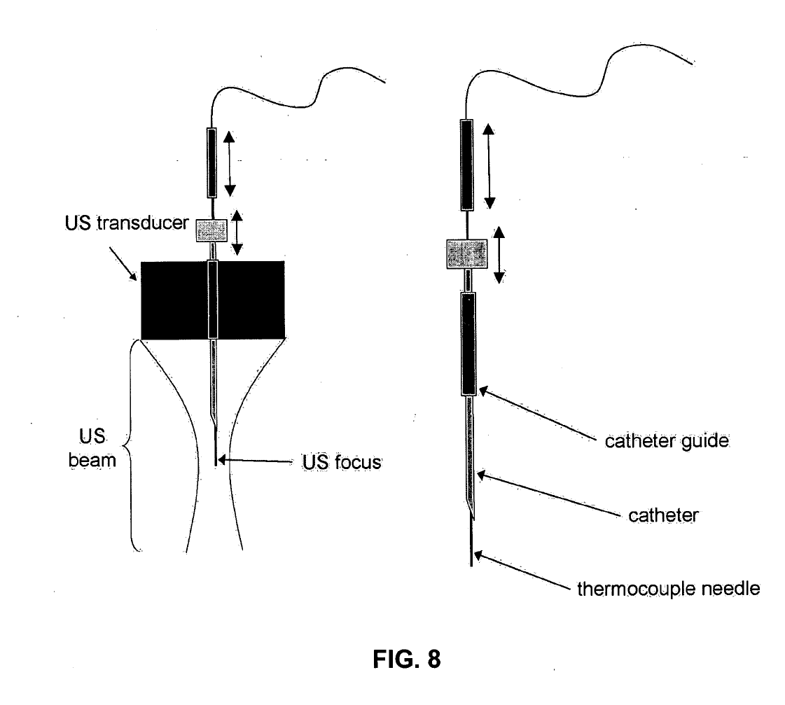

Referring to FIGS. 7 and 8, the shutter device according to the second exemplary embodiment of the present disclosure may include the base 10, first and second electromagnets 220a, 220b, a driving arm 230, a magnet 235, the FPCB 40, and the first and second shutters 50, 60.

The base 10 may include the body 11, which is formed in a circular shape, and the extension unit 18, which extends from the body 11.

The body 11 has the first and second shutters 50, 60 mounted slidably thereon, and at the center thereof the first light emission hole 11a through which light passes. The body 11 includes the plurality of fixing protrusions 15 along an outer periphery so that the FPCB 40 is fixed on the body 11, and the fixing shaft 16 which operates as a hinge shaft of the first and second shutters adjacent to the extension unit 18. The body 11 includes first and second projections 11b, 11c to limit the rotating angle of the first and second shutters 50, 60 so that the first and second shutters 50, 60 do not deviate from the body 11.

The extension unit 18 rotatably supports the driving arm 230, and the first and second electromagnets 220a, 220b are disposed together with the driving arm 230.

The first electromagnet 220a includes a first bobbin 221 and a first coil unit 222. The first bobbin 221 includes two ends, wherein first and second magnetic pole generators 221a, 221b are formed on respective ends of one part, and the first coil unit 222 is wound around the second end. The interval between the first and second magnetic pole generators 221a, 221b may be the same as or shorter than the length of the magnet 235.

The second electromagnet 220b is disposed so as to be symmetrical to the first electromagnet 20a based on the first light emission hole 11a. The second electromagnet 220b is implemented with identical components to the first electromagnet 220a. That is, the second electromagnet 220b includes a second bobbin 223 and a second coil unit 224. The second bobbin 223 includes two ends, wherein third and fourth magnetic pole generators 223a, 223b are formed on respective ends of one part, and the second coil unit 224 is wound around the second end. The interval between the third and fourth magnetic pole generators 223a, 223b may be the same as or shorter than the length of the magnet 235 in the same manner as the interval between the first and second magnetic pole generator 221a, 221b.

The driving arm 230 includes first and second hinge protrusions 231, 232 on upper and lower ends of a portion so that the driving arm 230 rotates in the connection hole 19, and a connection protrusion 233 on an upper end of another portion. The connection protrusion 233 is slidably inserted into the first and second long holes 53, 63 of the first and second shutter 50, 60. If the driving arm 230 rotates in a clockwise or counter-clockwise direction, the first and second shutters 50, 60 are rotated in a direction of the first and second shutters 50, 60, or a reverse direction.

The magnet 235 is fixed to an inserting hole 234 formed on the center of the driving arm 230, and is disposed between the first to fourth magnetic pole generators 221a, 221b, 223a, 223b of the first and second bobbins 221, 223 so as to be affected by the magnetic field. The magnet 235 is fixed to the inserting hole 234 so that both ends of the magnet 235 protrude a predetermined distance therefrom.

The magnet 235 is polarized to provide two poles on each end, and the two poles on each end are opposed to each other. The first part 235a of the magnet 235 between the first and third magnetic pole generators 221a, 223a provides the S pole on the part opposite the first magnetic pole generator 221a and the N pole on the part opposite the third magnetic pole generator 223a as shown in FIG. 2. The second part 235b of the magnet 235 between the second and fourth magnetic pole generators 221b, 223b provides the N pole on the part opposite the second magnetic pole generator 221b and the S pole on the part opposite the fourth magnetic pole generator 223b as shown in FIG. 2. The poles of the magnet 235 may be polarized on both surfaces of the magnet 235 adjacent to the first to fourth magnetic pole generators 221a, 221b, 223a, 223b.

The FPCB 40 includes a circuit unit, and applies the current flowing on the first and second coil units 22, 24. The FPCB 40 includes the plurality of fixing grooves 45 into which the plurality of fixing protrusions 15 of the body 11 are inserted, and thus is mounted safely in the upper portion of the body 11 while covering the first and second shutters 50, 60. The FPCB 40 includes a second light emission hole 40a which is the same size as or smaller than the first light emission hole 11a at the center of the FPCB 40. The FPCB 40 includes the through hole 41 through which the fixing shaft 16 of the body 11 is inserted and a long hole 43 through which the connection protrusion 233 of the driving arm 230 is slidably inserted. In this case, the length of the long hole 43 may be same as or longer than the rotating angle of the driving arm 230.

While the FPCB 40 is used in the second exemplary embodiment of the present disclosure, covers made of conventional plastic or metal may also be used. The first and second coil unit 222, 224 may also receive current from a camera body.

The first shutter 50 may include the first fixing hole 51, the first long hole 53, and the first main hollow unit 55. The fixing shaft 16, which is a rotating shaft of the first shutter 50, is hingeably inserted into the first fixing hole 51, and the connection protrusion 33 is slidably inserted into the first long hole 53 so that the first shutter 50 rotates in the same direction as the driving arm 30. The first long hole 53 is formed on part of the first shutter 50 adjacent to the first fixing hole 51.

The first shutter 50 includes the first main hollow unit 55, which is the same size as or larger than the first light emission hole 11a, on part of the first shutter 50, since the first light emission hole 11a opens completely when the first main hollow unit 55 corresponds to the circumference of the first light emission hole 11a. In this case, the first shutter 50 sets the length of the first long hole 53 appropriately, and thus limits the rotating angle of the first main hollow unit 55 to correspond to the first light emission hole 11a.

The second shutter 60 is disposed opposite the first shutter 50, and includes the second fixing hole 61, the second long hole 63, and the second main hollow unit 65 in the same manner as the first shutter 50. The fixing shaft 16 inserted into the first fixing hole 51 is hingeably inserted into the second fixing hole 61, and the connection protrusion 233 inserted into the first long hole 53 is slidably inserted into the second long hole 63. The second long hole 63 is formed on part of the second shutter 60 adjacent to the second fixing hole 61.

The second shutter 60 is formed in identical manner to the first shutter 50. That is, the second shutter 60 includes the second main hollow unit 65, which is the same size as or larger than the second light emission hole 40a, on part of the second shutter 60, since the second light emission hole 40a opens completely when the second main hollow unit 65 corresponds to the circumference of the second light emission hole 40a. The second shutter 60 sets the length of the second long hole 63 appropriately, and thus limits the rotating angle of the second main hollow unit 65 so as to correspond to the second light emission hole 40a.

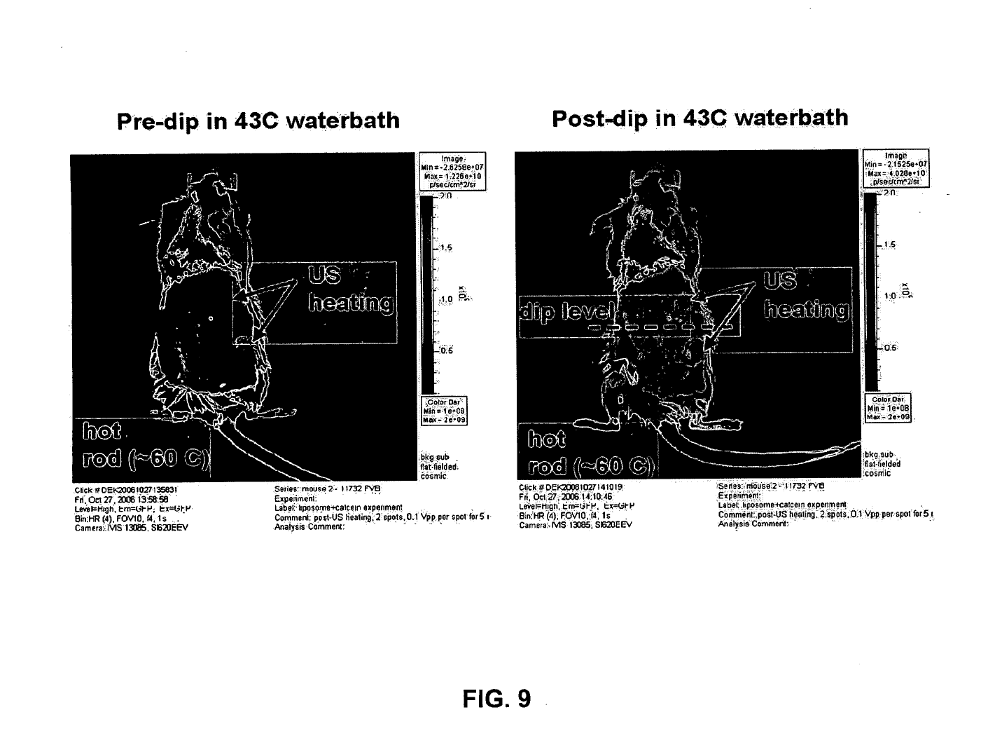

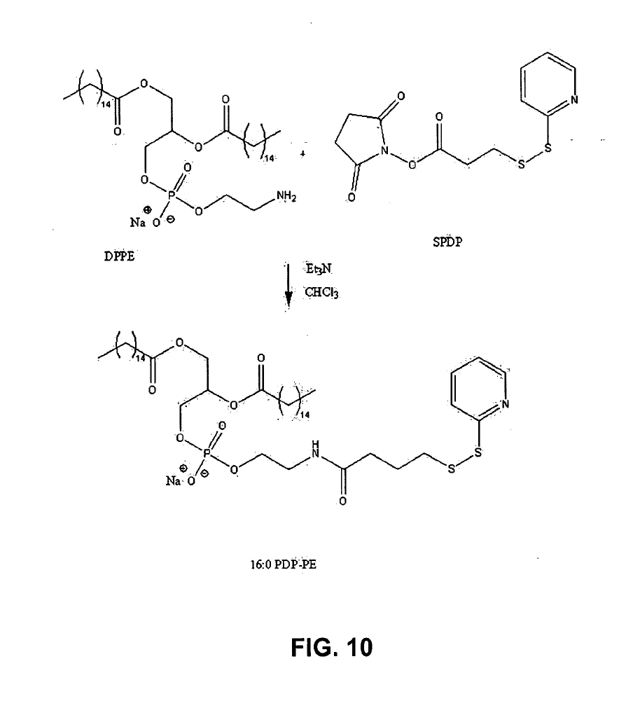

The operation of the shutter device according to the second exemplary embodiment of the present disclosure will be explained below with reference to FIGS. 9 and 10. In this exemplary embodiment, the FPCB 40 is omitted so as to clearly describe the operations of the first and second shutters 50, 60 for convenience of description, but the second light emission hole 40a of the FPCB 40 is described.

Referring to FIG. 9, when the shutter device according to the first exemplary embodiment of the present disclosure, for example a camera (not shown), is turned on, or when a mobile phone (not shown) on which a camera is mounted is set to a photography mode, the first and second shutters 50, 60 close completely the second light emission hole 40a, and thus a film or a charge coupled device (CCD) is set to an initial condition, in which the film or the CCD is not exposed to a light source.

If a shutter button (not shown) is pressed to take a photograph, the first and second shutters 50, 60 rotate instantaneously, thereby causing the second light emission hole 40a to open as shown in FIG. 4. The process of converting the second light emission hole 40a from being closed (referring to FIG. 9) to being completely opened (referring to FIG. 10) will be explained in detail.

If current is simultaneously applied to the first and second coil unit 222, 224 of the first and second electromagnets 220a, 220b, a magnetic field having the same pole, that is the S pole, is formed on the first to fourth magnetic pole generators 221a, 221b, 223a, 223b of the first and second bobbins 221, 223 adjacent to the magnet 235.

Repulsion occurs between the S pole of first end 235a of the magnet 235 and the first magnetic pole generator 221a of the first bobbin 221, and magnetic attraction occurs between the N pole of first end 235a of the magnet 235 and the third magnetic pole generator 223a of the second bobbin 223 as shown in FIG. 10. At the same time, magnetic attraction occurs between the N pole of the second end 235b of the magnet 235 and the second magnetic pole generator 221b of the first bobbin 221, and repulsion occurs between the S pole of the second end 235b of the magnet 235 and the fourth magnetic pole generator 223b of the second bobbin 223.

The driving arm 230 rotates in a clockwise direction about the first and second hinge protrusions 231, 232 (referring to FIG. 8), and the connection protrusion 233 slides along the first and second long holes 53, 63 of the first and second shutters 50, 60. The first shutter 50 rotates in a counter-clockwise direction about the fixing shaft 16, and simultaneously the second shutter 60 rotates in a clockwise direction about the fixing shaft 16. Thus, the first and second main hollow units 55, 65 are disposed on the second light emission hole 40a so that the second light emission hole 40a is opened completely.

The process of closing the second light emission hole 40a, by which the shutter device of FIG. 10 is converted into the shutter device of FIG. 9, will be explained below.

If current is simultaneously applied to the first and second coil units 222, 224 in a direction opposite the direction in which the second light emission hole 4a is opened, a magnetic field having the N pole is formed on the first to fourth magnetic pole generators 221a, 221b, 223a, 223b of the first and second bobbins 221, 223 adjacent to the magnet 35 as shown in FIG. 9.

Magnetic attraction occurs between the S pole of the first end 235a of the magnet 235 and the first magnetic pole generator 221a of the first bobbin 221, and repulsion occurs between the N pole of the first end 235a of the magnet 235 and the third magnetic pole generator 223a of the second bobbin 223. At the same time, repulsion occurs between the N pole of the second end 235b of the magnet 235 and the second magnetic pole generator 221b of the first bobbin 221, and magnetic attraction occurs between the S pole of the second end 235b of the magnet 235 and the fourth magnetic pole generator 223b of the second bobbin 223.

The driving arm 30 rotates in a counter-clockwise direction about the first and second hinge protrusions 231, 232 (referring to FIG. 8), and the connection protrusion 233 of the driving arm 230 slides along the first and second long holes 53, 63 of the first and second shutters 50, 60. The first shutter 50 rotates in a clockwise direction about the fixing shaft 16, and simultaneously the second shutter 60 rotates in a counter-clockwise direction about the fixing shaft 16. Accordingly, the second light emission hole 40a is closed completely.

The shutter device according to this exemplary embodiment of the present disclosure causes the magnetic field generated from the first to fourth magnetic pole generators 221a, 221b, 223a, 223b of the first and second bobbins 221, 223 adjacent to each end 235a, 235b of the magnet 35 to concurrently generate magnetic attraction and repulsion, and enhances the rotational force of the driving arm 30. Therefore, the speed of the first and second shutters 50, 60 increases, and a photograph may be taken with high definition and high quality.

While the first bobbin 221 includes the first and second magnetic pole generators 221a, 221b, and the second bobbin 223 includes the third and fourth magnetic pole generators 223a, 223b in the second exemplary embodiment of the present disclosure, one of the first and second bobbins 221, 223 may include a magnetic pole generator polarized into two poles, and the other may use the magnetic pole generator providing only one pole. In this condition, if the first and second shutters 50, 60 are driven, the bobbin having the magnetic pole generator providing only one pole reduces repulsion occurring when poles of the first and second electromagnets 220a, 220b are reversed, thereby minimizing a delay time in response to drive the first and second shutters 50, 60. Therefore, the speed of driving the first and second shutters 50, 60 increases.

While the first and second electromagnets 220a, 220b are provided in the second exemplary embodiment, one of the first and second electromagnets 220a, 220b may be omitted. In this case, a magnet having the N and S poles on two surfaces may be used, or a stick magnet having the N and S poles on each end may also be used.

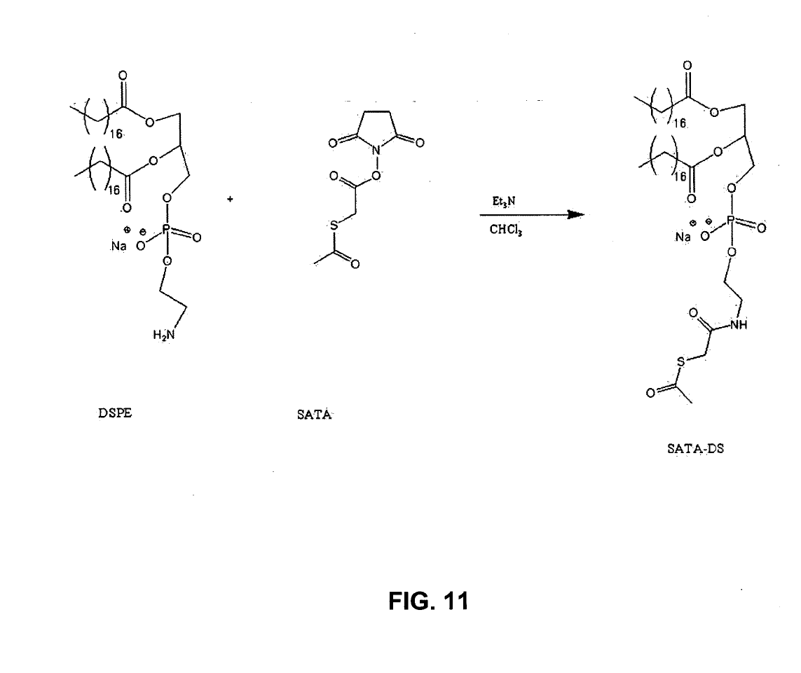

The shutter device according to the third exemplary embodiment of the present disclosure has a similar structure to that of the second exemplary embodiment of the present disclosure, but the first and second electromagnets 320a, 320b, and the magnet 335 differs in structure. The shutter device according to the third exemplary embodiment of the present disclosure will be explained with reference to FIG. 11, and a description of like elements will be omitted.

The first electromagnet 320a of the shutter device according to the third exemplary embodiment of the present disclosure may include a first bobbin 321 and a first coil unit 322 wound around the first bobbin 321. The N or S pole is formed on part of the first bobbin 321 adjacent to the magnet 335 in a direction in which current flows on the first coil unit 322.

The second electromagnet 320b may include a second bobbin 323 and a second coil unit 324 wound around the second bobbin 323. The N or S pole is formed on part of the second bobbin 323 adjacent to the magnet 335 in a direction in which current flows on the second coil unit 324.

The magnet 335 is formed in a ring shape, and different poles are formed on each end. Referring to FIG. 11, the N pole is formed on a first end adjacent to the first bobbin 321, and the S pole is polarized on a second end adjacent to the second bobbin 323.

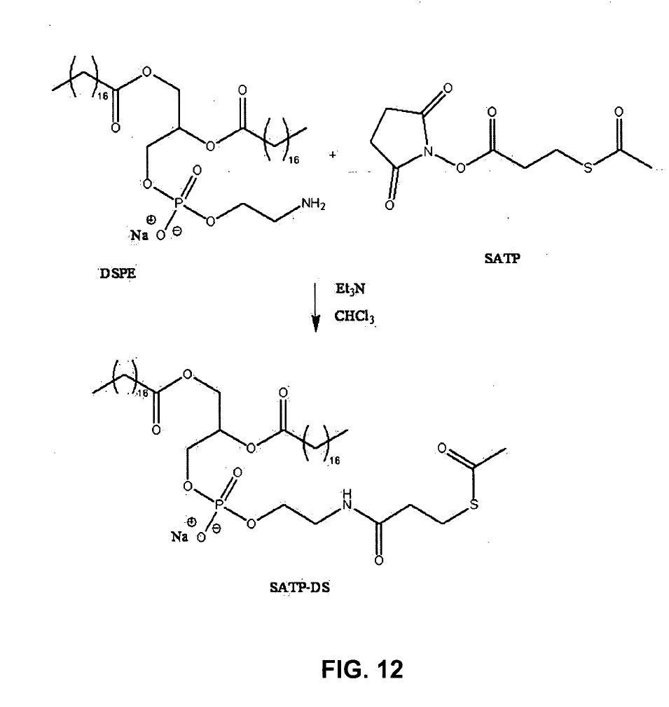

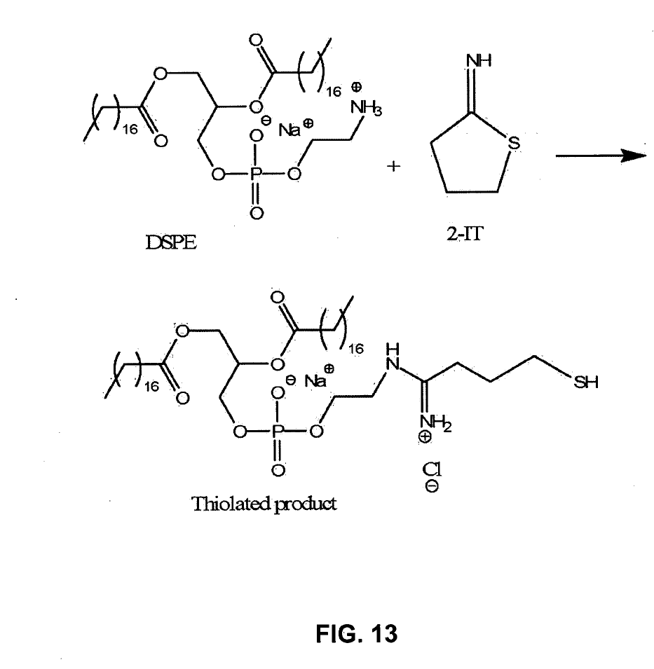

The operation of the shutter device according to the third exemplary embodiment of the present disclosure will be explained with reference to FIGS. 12 and 13.

In the third exemplary embodiment of the present disclosure, if a shutter button (not shown) is pressed to take a photograph, the first and second shutters 50, 60 rotate, thereby causing the second light emission hole 40a to open completely as shown in FIG. 13. The process of converting the second light emission hole 40a from being closed (referring to FIG. 12) to being completely opened (referring to FIG. 13) will be explained in detail.

If current is simultaneously applied to the first and second coil unit 322, 324 of the first and second electromagnets 320a, 320b in the same direction, a magnetic field having the same pole, that is the N pole, is formed on the part of the first and second bobbins 321, 323 adjacent to the magnet 335.

Repulsion occurs between the N pole of a first end of the magnet 335 and the N pole of the other part of the first bobbin 221, and magnetic attraction occurs between the S pole of a second end of the magnet 335 and the N pole of the part of the second bobbin 323 as shown in FIG. 13.

The driving arm 330 rotates in a clockwise direction about first and second hinge protrusions 331, 332 (referring to FIG. 11), and the connection protrusion 333 slides along the first and second long holes 53, 63 of the first and second shutters 50, 60. The first shutter 50 rotates in a counter-clockwise direction about the fixing shaft 16, and simultaneously the second shutter 60 rotates in a clockwise direction about the fixing shaft 16. Thus, the first and second main hollow units 55, 65 are disposed on the second light emission hole 40a so that the second light emission hole 40a is opened completely.

The process of closing the second light emission hole 40a, by which the shutter device of FIG. 13 is converted into the shutter device of FIG. 12, will be explained below.

If current is simultaneously applied to the first and second coil units 322, 324 in a direction opposite the direction in which the second light emission hole 40a opens, a magnetic field having the S pole is simultaneously formed on parts of the first and second bobbins 321, 323 adjacent to the magnet 335 as shown in FIG. 12.

Magnetic attraction occurs between the N pole of the first end of the magnet 335 and the S pole of part of the first bobbin 321, and simultaneously repulsion occurs between the S pole of the second end of the magnet 335 and the S pole of the part of the second bobbin 323.

The driving arm 330 rotates in a counter-clockwise direction about the first and second hinge protrusions 331, 332 (referring to FIG. 11), and the connection protrusion 333 of the driving arm 330 slides along the first and second long holes 53, 63 of the first and second shutters 50, 60. The first shutter 50 rotates in a clockwise direction about the fixing shaft 16, and the second shutter 60 rotates in a counter-clockwise direction about the fixing shaft 16. Accordingly, the second light emission hole 40a is closed completely.

The shutter device according to the third exemplary embodiment of the present disclosure causes magnetic attraction and repulsion to occur on each end of the magnet 335, thereby enhancing the rotational force of the driving arm 30.

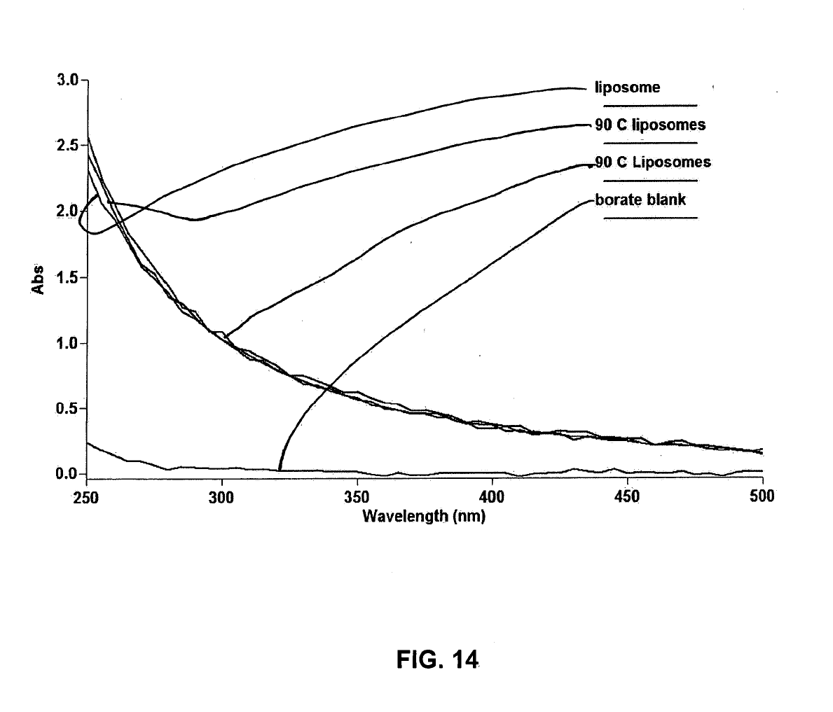

The shutter device according to the fourth exemplary embodiment of the present disclosure may include the same elements as the second exemplary embodiment of the present disclosure, but first and second electromagnets 420a, 420b, and first and second magnets 435a, 435b are different from those of the second exemplary embodiment of the present disclosure. Therefore, the shutter device according to the fourth exemplary embodiment of the present disclosure will be explained with reference to FIG. 14, and elements in common with the second exemplary embodiment of the present disclosure will be omitted.

The first electromagnet 420a of the shutter device according to the fourth exemplary embodiment of the present disclosure may include first lower and upper bobbins 421a, 421b which are overlapped, and a first coil unit 422 wound around the overlapped first lower and upper bobbins 421a, 421b. The same N or S pole is formed on parts of the first lower and upper bobbins 421a, 421b adjacent to the magnet 435 in a direction in which current flows on the first coil unit 422.

The second electromagnet 420b may also include first lower and upper bobbins 423a, 423b which are overlapped, and a second coil unit 424 wound around the overlapped second lower and upper bobbins 423a, 423b. The same N or S pole is formed on parts of the second lower and upper bobbins 423a, 423b adjacent to the magnet 435 in a direction in which current flows on the second coil unit 424.

The first magnet 435a is disposed under a rotating portion of the driving arm 430, and is formed in a semi-circular shape. The first magnet 435a includes different poles at each end. Referring to FIG. 14, the S pole is formed on a first end of the first magnet 435a adjacent to the first lower bobbin 421a, and the N pole is formed on a second end of the first magnet 435a adjacent to the second lower bobbin 423a.

The second magnet 435b is disposed on the rotating portion of the driving arm 430, and is formed in a stick shape bent at a predetermined angle in a middle portion. The second magnet 435b includes different poles on each end. The N pole is formed on a first end of the second magnet 435b adjacent to the first upper bobbin 421b, and the S pole is formed on a second end of the second magnet 435b adjacent to the second upper bobbin 423b. The first and second magnets 435a, 435b are overlapped so that different poles are disposed on top and bottom portions.

The N and S poles of the second magnet 453b are disposed so as to be slanted to the N and S poles of the first magnet 453a. In doing so, the first upper and lower bobbins 421a, 421b are biased towards each other, and parts of the second upper and lower bobbins 423a, 423b are biased each other. The first and second upper bobbins 421b, 423b opposite the first magnet 453a are bent at a predetermined angle in the same direction, and the first and second lower bobbins 421a, 423a opposite the second magnet 453b are bent at a predetermined angle in an opposite direction.

The above bent shape minimizes the first magnet 435a from being affected by the first and second upper bobbins 421b, 423b, and the second magnet 435b from being affected by the first and second lower bobbins 421a, 423a, thereby obviating the risk of the driving arm 430 malfunctioning.

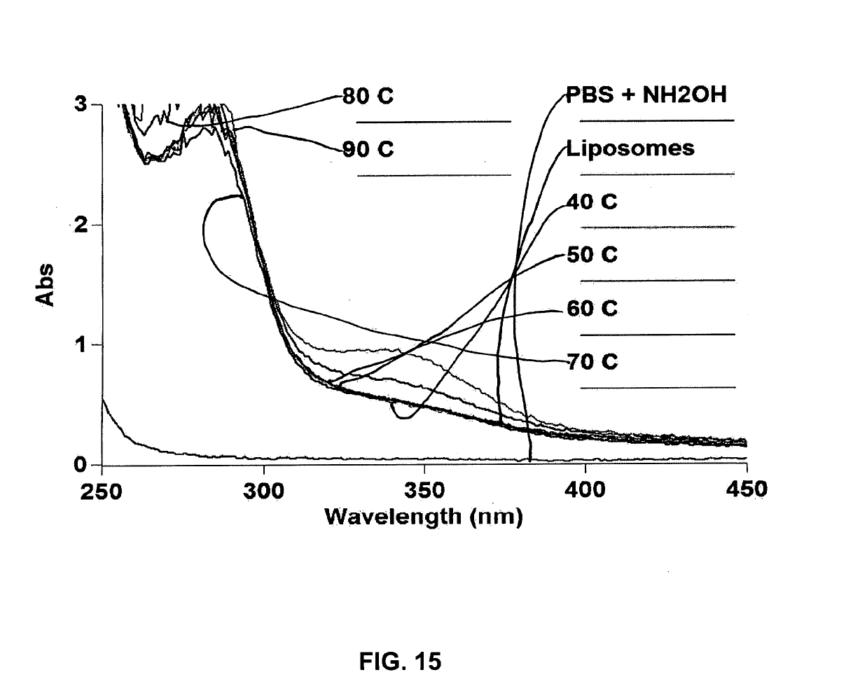

The operation of the shutter device according to the fourth exemplary embodiment of the present disclosure will be explained with reference to FIGS. 15 to 18.

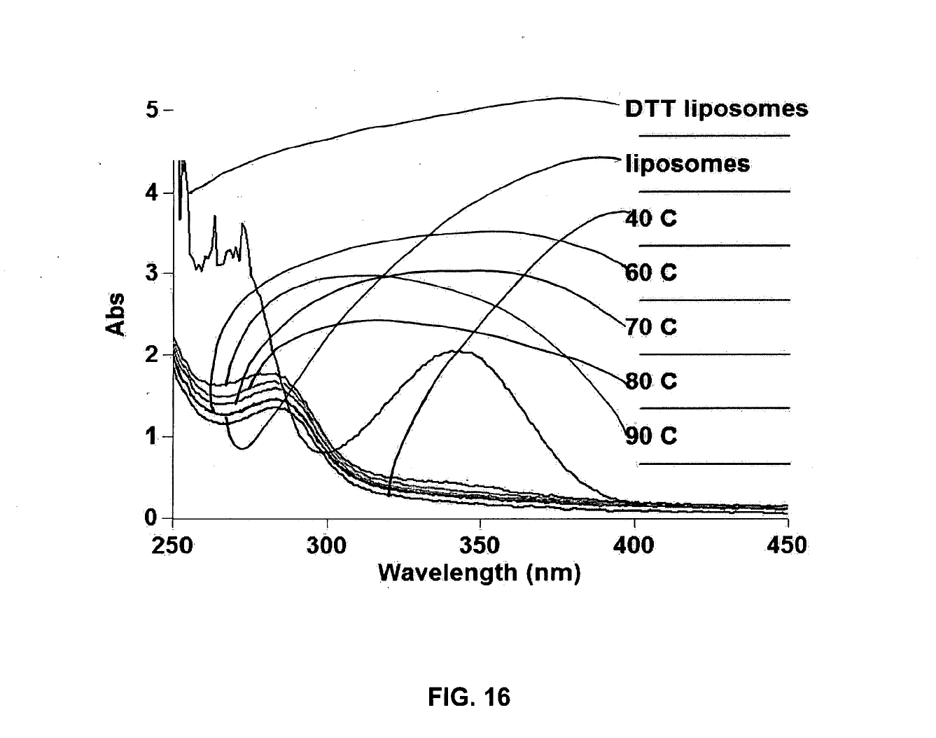

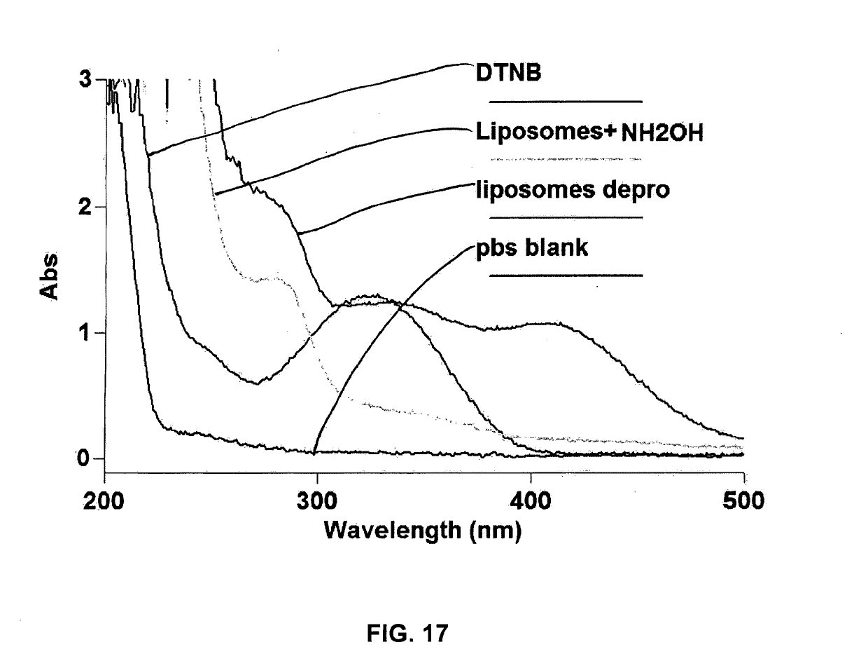

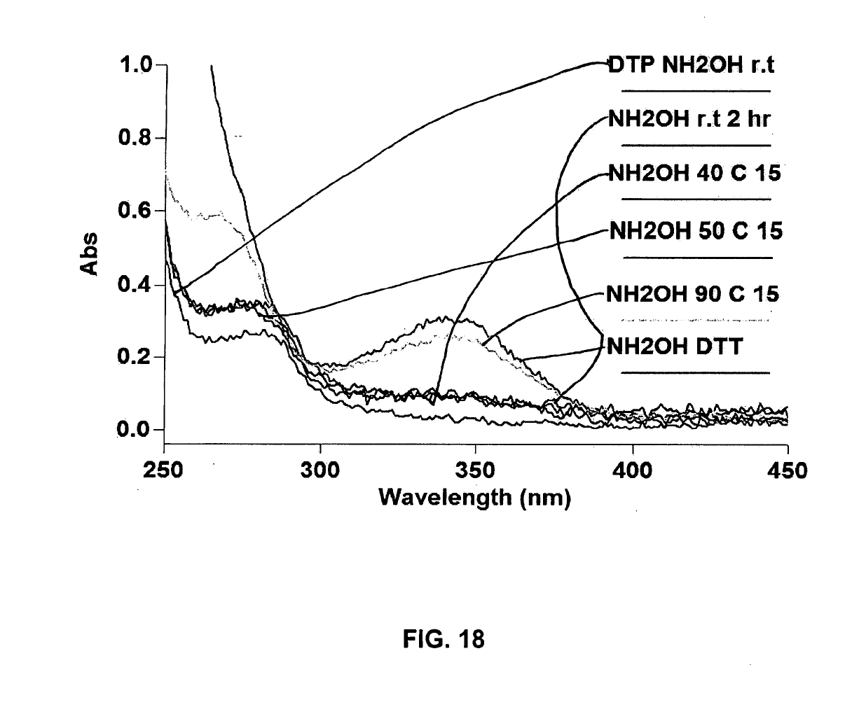

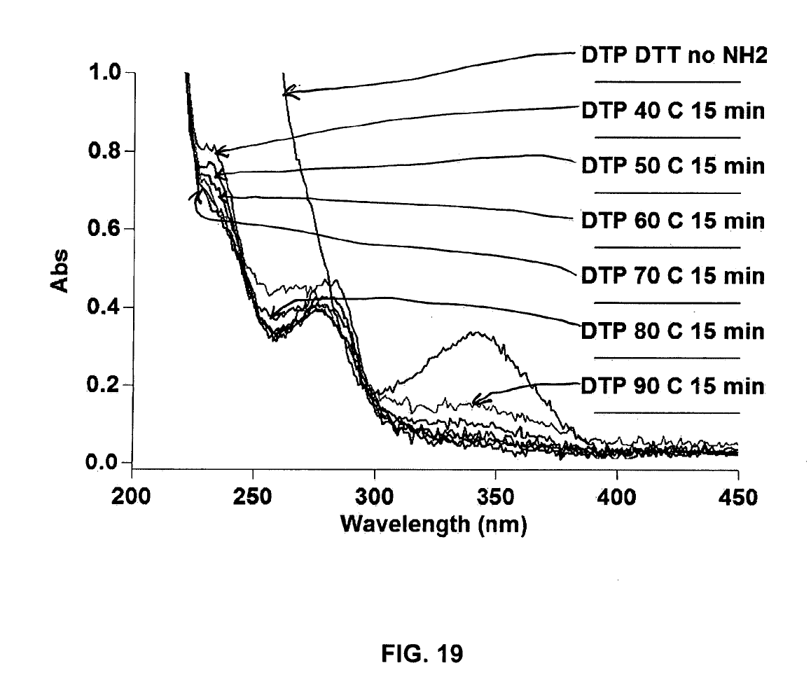

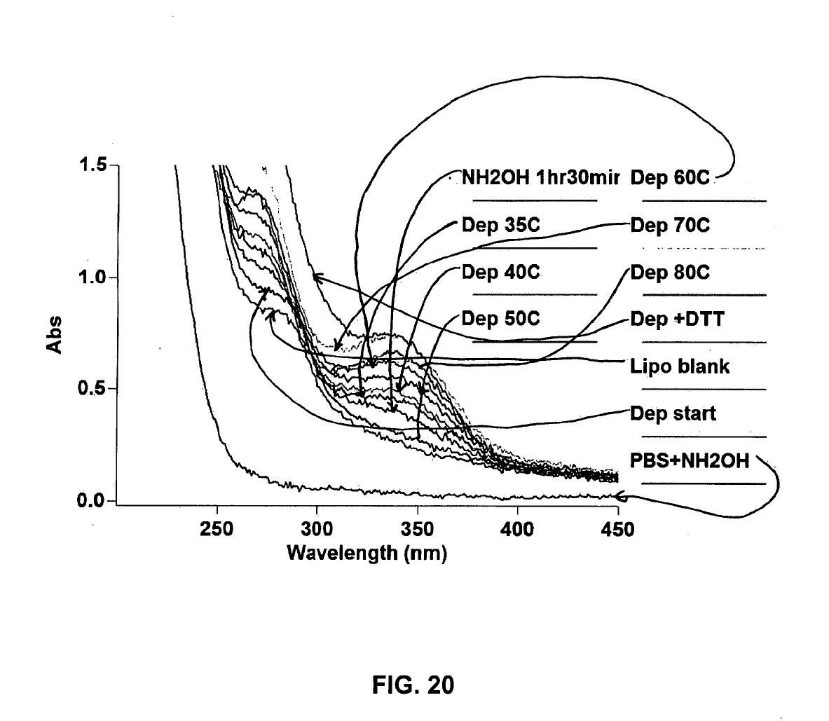

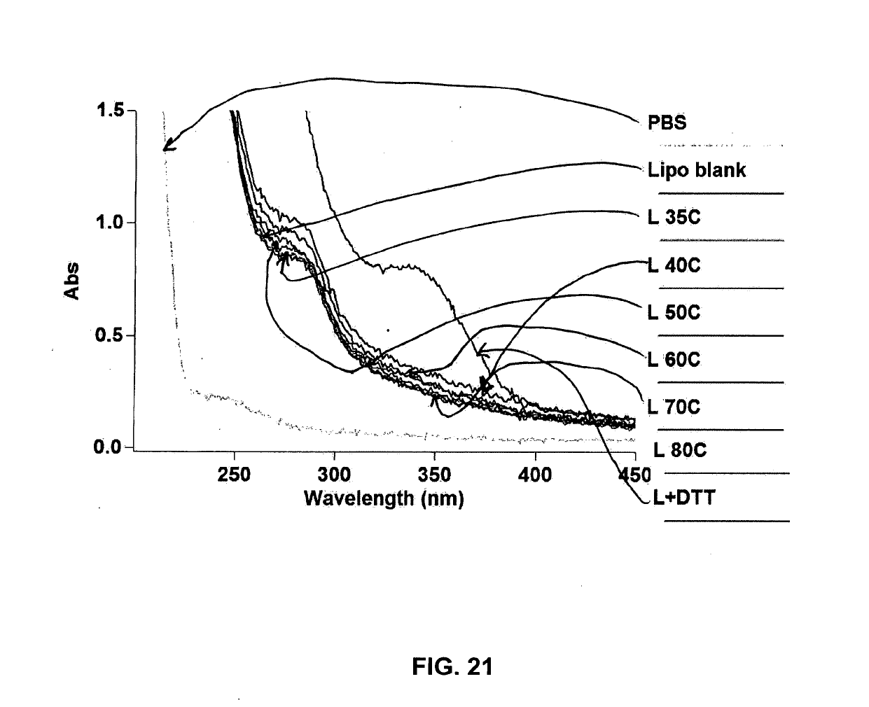

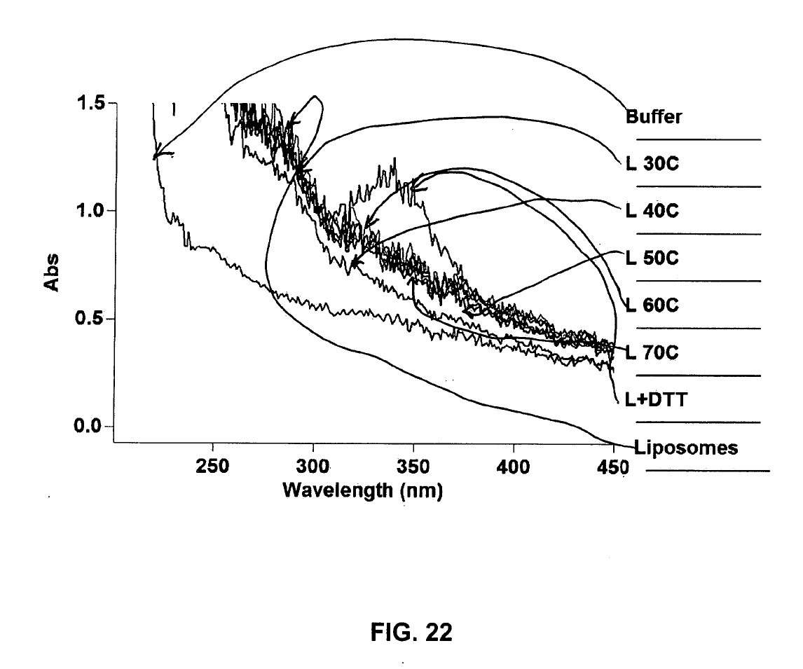

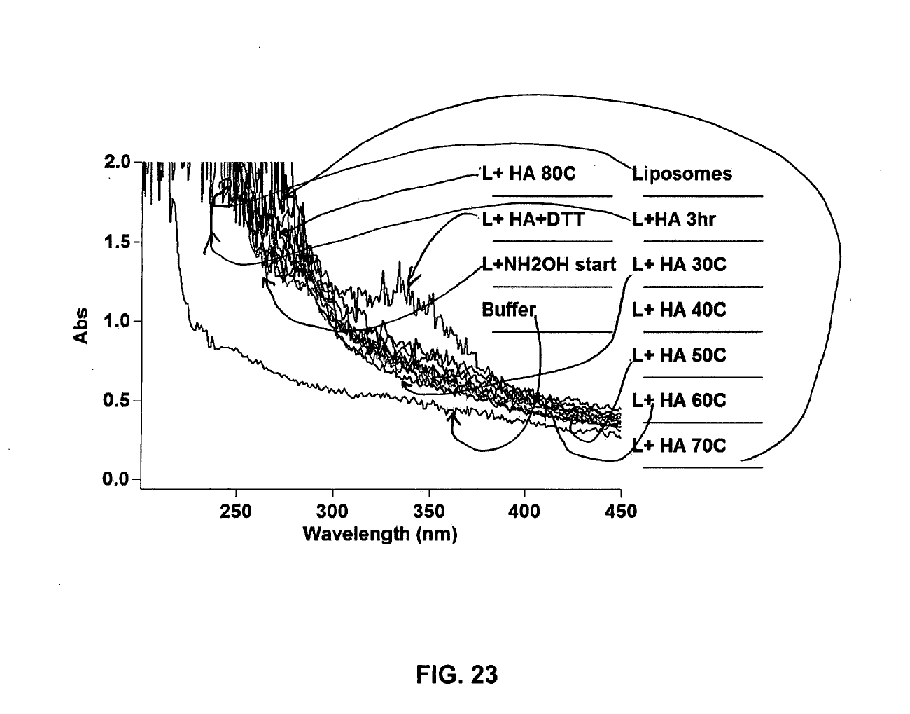

In the fourth exemplary embodiment of the present disclosure, if a shutter button (not shown) is pressed to take a photograph, the first and second shutters 50, 60 rotate as shown in FIG. 13, thereby completely opening the second light emission hole 40a. The process of converting the second light emission hole 40a from being closed (referring to FIGS. 15 and 16) to completely opened (referring to FIGS. 17 and 18) will be explained in detail.

If current is simultaneously applied to the first and second coil unit 422, 424 of the first and second electromagnets 420a, 420b, a magnetic field having the same pole, that is the N pole, is formed on parts of the first lower and upper bobbins 421a, 421b, and parts of the second lower and upper bobbins 423a, 423b at the same time.

Magnetic attraction occurs between the S pole of the first end of the first magnet 435a and the N pole of the part of the first lower bobbin 421a, and repulsion occurs between the N pole of the second end of the first magnet 435a and the N pole of the part of the second lower bobbin 232a. At the same time, repulsion occurs between the N pole of the first end of the second magnet 435b and the N pole of the part of the first upper bobbin 421b, and magnetic attraction occurs between the S pole of the second end of the second magnet 435b and the N pole of the part of the second upper bobbin 423b.

The driving arm 30 rotates in a clockwise direction about the first and second hinge protrusions 431, 432 (referring to FIG. 14), and the connection protrusion 433 slides along the first and second long holes 53, 63 of the first and second shutters 50, 60. The first shutter 50 rotates in a counter-clockwise direction about the fixing shaft 16, and the second shutter 60 rotates in a clockwise direction about the fixing shaft 16. Thus, the first and second main hollow units 55, 65 are disposed on the second light emission hole 40a so that the second light emission hole 40a is opened completely.

The process of closing the second light emission hole 40a, by which the shutter device of FIG. 17 is converted into the shutter device of FIG. 15, will be explained below.

If current is simultaneously applied to the first and second coil units 422, 424 in a direction opposite the direction in which the second light emission hole 40a is opened, a magnetic field having the S pole is formed on parts of the first lower and upper bobbins 421a, 421b and parts of the second lower and upper bobbins 423a, 423b as shown in FIGS. 15 and 16.

Repulsion occurs between the S pole of the first end of the first magnet 435a and the S pole of the part of the first lower bobbin 421a, and magnetic attraction occurs between the N pole of the second end of the first magnet 435a and the S pole of the part of the second lower bobbin 323a. At the same time, magnetic attraction occurs between the N pole of the first end of the second magnet 435b and the S pole of the part of the first upper bobbin 421b, and repulsion occurs between the S pole of the second end of the second magnet 465b and the S pole of part of the second upper bobbin 423b.

The driving arm 430 rotates in a counter-clockwise direction about the first and second hinge protrusions 431, 432 (referring to FIG. 14), and the connection protrusion 433 slides along the first and second long holes 53, 63 of the first and second shutters 50, 60. The first shutter 50 rotates in a clockwise direction about the fixing shaft 16, and the second shutter 60 rotates in a counter-clockwise direction about the fixing shaft 16. Accordingly, the first and second main hollow unit 55, 65 are disposed on the second light emission hole 40a, thereby completely closing the second light emission hole 40a.

The shutter device according to the fourth exemplary embodiment of the present disclosure causes magnetic attraction and repulsion to be generated concurrently at each end of the first and second magnets 435a, 435b, thereby enhancing the rotational force of the driving arm 430.

1. A shutter device for a camera, comprising:
a base which forms a light emission hole through which light passes so that a film or Charge Coupled Device (CCD) is exposed to a light source;
first and second electromagnets which are mounted on respective sides of the base to oppose each other;
a driving arm of which a part is disposed between the first and second electromagnets, and is rotatably connected to the side of the base;
first and second shutters which rotate about a part of the base engaged with the driving arm, and opens the light emission hole; and
a magnet which is disposed on the part of the driving arm between the first and second electromagnets, which moves between the first and second electromagnets in a direction in which current applied to the first and second electromagnets flows, and which rotates the driving arm in a clockwise or counter-clockwise direction.

2. The device of claim 1, wherein the magnet is polarized to provide N and S poles.

3. The device of claim 2, wherein poles having the same polarity occur on first ends of the first and second electromagnets at the same time.

4. The device of claim 1, wherein the magnet is polarized to provide sequential N, S, N poles or sequential S, N, S poles.

5. The device of claim 4, wherein different poles occur concurrently on the first end of the first and second electromagnets adjacent to both ends of the magnet.

6. A shutter device for a camera, comprising:
a base which forms a light emission hole through which light passes so that a film or Charge Coupled Device (CCD) is exposed to a light source;
first and second electromagnets which are mounted in corresponding portions on a side of the base;
a driving arm which is rotatably disposed between the first and second electromagnets;
first and second shutters which rotate about a part of the base engaged with the driving arm, and opens the light emission hole; and
at least one magnet which is disposed on a part of the driving arm,
wherein the driving arm which is configured to rotate in a clockwise or counter-clockwise direction by magnetic attraction and repulsion occurring between the first and second magnets in a direction in which current applied to the first and second electromagnets flows.

7. The device of claim 6, wherein
the first electromagnet comprises a first bobbin and a first coil wound around the first bobbin,
wherein the first bobbin comprises first and second magnetic pole generators on parts thereof adjacent to the magnet; and
the second electromagnet comprises a second bobbin and a second coil wound around the first bobbin,
wherein the second bobbin comprises third and fourth magnetic pole generators on parts thereof adjacent to the magnet, and
the first and third magnetic pole generators and the second and fourth magnetic pole generators oppose to each other.

8. The device of claim 7, wherein N and S poles are formed on a first end of the magnet disposed between the first and third magnetic pole generators, and S and N poles are formed on a second end of the magnet disposed between the second and fourth magnetic pole generators, or
S and N poles are formed on the first end of the magnet disposed between the first and third magnetic pole generators, and N and S poles are formed on the second end of the magnet disposed between the second and fourth magnetic pole generators.

9. The device of claim 6, wherein the first electromagnet comprises a first bobbin and a first coil wound around the first bobbin, and the second electromagnet comprises a second bobbin and a second coil wound around the first bobbin, and
the first bobbin comprises two magnetic pole generators on a part adjacent to the magnet, and the second bobbin comprises a magnetic pole generator on a part adjacent to the magnet, or
the first bobbin comprises a magnetic pole generator on the part adjacent to the magnet, and the second bobbin comprises two magnetic pole generators on the part adjacent to the magnet.

10. The device of claim 9, wherein opposite poles such as N and S poles are formed on first and second ends of the magnet, and a pair of poles formed on the first end of the magnet oppose a pair of poles formed on the second end of the magnet, wherein the opposing poles differ from each other.

11. The device of claim 6, wherein the magnet is formed in a ring shape, and N and S poles or S and N poles are formed on the ends corresponding to the first and second electromagnets.

12. The device of claim 11, wherein identical poles simultaneously occur on the parts of the first and second electromagnets adjacent to first and second ends of the magnet.

13. The device of claim 6, wherein the first electromagnet comprises a first lower bobbin, a first upper bobbin mounted on an upper portion of the first lower bobbin, and a second coil unit wound around the first lower and upper bobbins; and
the second electromagnet comprises a second lower bobbin, a second upper bobbin mounted on an upper portion of the second lower bobbin, and a second coil unit wound around the first lower and upper bobbins.

14. The device of claim 13, wherein the magnet comprises a first magnet disposed between the first and second lower bobbins and a second magnet disposed between the first and second upper bobbins.

15. The device of claim 14, wherein N and S poles or S and N poles are formed on respective ends opposing the first and second lower bobbins, and
N and S poles or S and N poles are formed on respective ends opposing the first and second upper bobbins,
wherein the poles formed on the respective ends of first and second magnets oppose to each other, and the opposing poles differ from each other.

16. The device of claim 15, wherein the opposing poles formed on the both ends of the first and second magnets are disposed on a slant.

17. The device of claim 15 or 16, wherein one of the first and second magnets is formed in a ring shape, and another magnet is formed in a bent stick shape.

18. The device of claim 17, wherein the parts of the first and second lower bobbins opposing the first magnet are bent in the same direction, and
the parts of the first and second upper bobbins opposing the second magnet are bent in a direction opposite the direction of the first and second lower bobbins.

19. A shutter device for a camera, comprising:
a base which forms a light emission hole through which light passes so that a film or Charge Coupled Device (CCD) is exposed to a light source;
an electromagnet which are mounted in corresponding positions on a side of the base to correspond to each other;
a driving arm which is rotatably disposed adjacent to the electromagnet mounted on the side of the base;
first and second shutters which rotate about a part of the base engaged with the driving arm, and opens the light emission hole; and
at least one magnet which is disposed on a part of the driving arm,
wherein the driving arm which is configured to rotate in a clockwise or counter-clockwise direction by magnetic attraction and repulsion occurring between the first and second magnets in a direction in which current applied to the first and second electromagnets flows, and operates the first and second shutters.

20. The device of claim 19, wherein the electromagnet comprises a bobbin and a coil unit wound around the bobbin,
wherein a part of the bobbin adjacent to the magnet is divided, and generates a pair of magnetic pole generators adjacent to the part of the magnet.

21. The device of claim 20, wherein N and S poles are formed on part of, or on first and second ends of, the magnet.
